(19) United States
(12) Patent Application Publication
(10) Pub. No.: US 2008/0278646 A1
(43) Pub. Date: Nov. 13, 2008

(54) PIXEL AND DRIVING METHOD THEREOF FOR OPTICALLY COMPENSATED BEND MODE LIQUID CRYSTAL DISPLAY

(75) Inventors: Yao-Hong Chien, Taoyuan County (TW); Chih-Chieh Wang, Taipei County (TW); Szu-Fen Chen, Taoyuan (TW); Jung-Chieh Cheng, Changhua County (TW); Li-Shan Chen, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 12/054,396

(22) Filed: Mar. 25, 2008

(30) Foreign Application Priority Data
May 8, 2007 (TW) 96116272

(51) Int. Cl. G02F 1/136

(52) U.S. Cl. 349/39

(57) ABSTRACT

A pixel including a transistor, a liquid crystal capacitor, a storage capacitor and a coupling capacitor is provided. The first end of the transistor is connected to a data line, the liquid crystal capacitor and the storage capacitor are coupled between the second end of the transistor and a common voltage, and the coupling capacitor is connected between the second end of the transistor and a select line. After a driving voltage is outputted to the liquid crystal capacitor and the storage capacitor by the data line, the select line inputs a pulse signal to the liquid crystal capacitor through the coupling capacitor. The pulse signal is capable of increasing the ability of the electric field for driving the liquid crystal so that the liquid crystal can still display normally in the bend state even though the lowest pixel voltage is lower than the critical voltage.

### CROSS-REFERENCE TO RELATED APPLICATION

This application claims the priority benefit of Taiwan application serial no. 96116272, filed on May 8, 2007. The entirety the above-mentioned patent application is hereby incorporated by reference herein and made a part of specification.

### BACKGROUND OF THE INVENTION

1. Field of the Invention

The present invention generally relates to an Optically Compensated Bend mode Liquid Crystal Display (OCB LCD), and more particularly to a pixel and driving method thereof for an OCB LCD.

2. Description of Related Art

To correspond with our modern living style, the volume and weight of video or image devices are decreasing all the time. Although the conventional Cathode Ray Tube (CRT) still has its advantages, the electron gun structure renders the display bulky, and the radiation produced by the electrons bombarding the fluorescent screen is also harmful to the human eyes. Therefore, through the rapid development of optical-electrical technology and semiconductor processing technology, flat panel displays such as Liquid Crystal Display (LCD), Organic Light-Emitting Display (OLED) or Plasma Display Panel (PDP) have become the mainstream display product.

In the field of LCD, the OCB LCD has a fast response and a wide viewing angle. With these advantages, OCB LCD has great potential for developing into large LCD. However, the leakage current problem of Thin Film Transistor (TFT) is the common bottleneck encountered by all kinds of LCD, particularly for OCB LCD. FIG. 1 is a state response diagram of conventional liquid crystal with OCB mode. As shown in FIG. 1, an OCB LCD has two operating states. When the voltage difference VPC (Vpixel−Vcom) of the liquid crystal is lower than the critical voltage VCR, the liquid crystal is in a splay state with lower free energy. Otherwise, the liquid crystal is in a bend state with higher energy. The light transmittance is difficult to control when the liquid crysta is in the splay state. To obtain better display quality, the liquid crystal is normally used in the bend state. In this way, the liquid crystal is better able to display a fast response when the display changes from a white image to a black image.

When the liquid crystal is in a bend state, the only thing that needs to be considered is that the white state voltage VPCW (the voltage across liquid crystals during displaying a white image) must be higher than the critical voltage VCR. Otherwise, the liquid crystal may drop back from bend state with higher free energy to the splay state with lower free energy. However, due to the effect of leakage current from TFT or liquid crystal capacitor, the white state voltage VPCW in partial areas of the display panel may be lower than the critical voltage VCR. Therefore, the liquid crystals in the areas may revert back to the splay state so that an abnormal image is displayed. To resolve this problem, the white state voltage VPCW is normally increased so as to maintain the liquid crystals in the bend state with higher free energy. Although this method can prevent the appearance of abnormal images, the light transmittance of the liquid crystals with a white image is sacrificed.

### SUMMARY OF THE INVENTION

Accordingly, the present invention provides a pixel that can be applied to an Optically Compensated Bend mode Liquid Crystal Display. Together with the driving method of the present invention, a low white state voltage in the bend state is obtained so as to increase the light transmittance during displaying a white image.

The present invention also provides a Liquid Crystal Display that utilizes an over-driving voltage to maintain the white state voltage of the OCB LCD at a lower voltage potential without getting into the splay state. As a result, the light transmittance with a white image is increased so that a brighter white image is obtained.

The present invention also provides a pixel driving method. After charging a liquid crystal capacitor, an over-driving voltage is coupled to the liquid crystal capacitor so as to prevent the liquid crystal from getting into the splay state. Therefore, the white state voltage can be lower so that the light transmittance with a white image is increased and a brighter white image is obtained.

According to an embodiment of the present invention, a pixel is provided. The pixel includes a transistor, a liquid crystal capacitor, a storage capacitor and a coupling capacitor. A first end of the transistor is connected to a data line, and a gate of the transistor is connected to a scan line. The liquid crystal capacitor and the storage capacitor are coupled between a second end of the transistor and a common voltage. The coupling capacitor is connected between the second end of the transistor and a select line.

In a preferred embodiment of the present invention, after a driving voltage is outputted to the liquid crystal capacitor and the storage capacitor by the data line, the select line inputs an over-driving voltage to the coupling capacitor. Due to the capacitor coupling between the liquid crystal capacitor and the coupling capacitor, the over-driving voltage forms an impulse signal on the driving voltage. The foregoing impulse signal increases the pixel voltage due to coupling effect on capacitor and then lowers back to the original pixel voltage so that the root-mean-square value of the liquid crystal voltage is higher than the critical voltage. Therefore, even if the lowest pixel voltage of the liquid crystal is not high enough, the liquid crystal can still be maintained in the bend state to display images normally.

The present invention also provides a liquid crystal display that includes a first scan line, a plurality of data lines and a first select line. The first scan line corresponds with a plurality of first pixels. The data lines are used for driving the first pixels. The first select line outputs a first over-driving voltage to the first pixels according to the driving polarities of the data lines. After the data lines output driving voltages to the first pixels, the first select line outputs a first over-driving voltage to the first pixels.

In a preferred embodiment of the present invention, the liquid crystal display further includes a second scan line and a second select line. The second scan line corresponds with a plurality of second pixels. The data lines also drive the second pixels. The second select line outputs a second over-driving voltage to the second pixels according to the driving polarities of the data lines. After the data lines output driving voltages to the second pixels, the second select line outputs a second over-driving voltage to the second pixels.

The present invention also provides another liquid crystal display that includes a first data line and a first select line. The first data line is used for driving a plurality of first pixels. The first select line outputs a first over-driving voltage to the first pixels according to the driving polarities of the first data lines. After charging one of the first pixels through the first data line, the first select line outputs the first over-driving voltage to the first pixels.

According to a preferred embodiment of the present invention, the liquid crystal display further includes a second data line and a second select line. The second data line is used for driving a plurality of second pixels. The second select line outputs a second over-driving voltage to the second pixels according to the driving polarities of the second data lines. After charging one of the second pixels through the second data line, the second select line outputs the second over-driving voltage to the second pixels.

From another point of view, the present invention also provides another liquid crystal display that includes a scan line, a first select line and a second select line. The scan line corresponds with a first pixel and a second pixel. The first pixel corresponds with a first data line and the second pixel corresponds with a second data line. The first select line outputs a first over-driving voltage to the first pixel according to the driving polarity of the first data line. The second select line outputs a second over-driving voltage to the second pixel according to the driving polarity of the second data line. After charging the first pixel through the first data line, the first select line outputs a first over-driving voltage to the first pixel. After charging the second pixel through the second data line, the second select line outputs a second over-driving voltage to the second pixel. The first pixel is adjacent to the second pixel. Furthermore, the driving polarities of the first data line and the second data line are opposite to each other.

According to a preferred embodiment of the present invention, the foregoing liquid crystal displays can be row inversion mode, column inversion mode and dot inversion mode. Because the over-driving voltage increases the ability of the driving voltage to drive the liquid crystals, the liquid crystals will not change state due to an insufficiently high pixel voltage (lower than the critical voltage) during the liquid crystals displaying a white image.

The present invention also provides a pixel driving method that includes the following steps. First, a voltage is provided to a pixel. Thereafter, a coupling capacitor is used to couple an over-driving voltage to the pixel.

According to a preferred embodiment of the present invention, because the over-driving voltage forms an impulse signal on the white state voltage of the pixels in the foregoing pixel driving method, the overall root-mean-square (RMS) value of the white state voltage is greater than a critical value during the reaction time of the liquid crystals. Therefore, even though the lowest white state voltage is lower than the critical voltage, the liquid crystals can still be maintained in the bend state for displaying images normally. As a result, the operating voltage range of the pixel is increased.

From another point of view, the present invention also provides a pixel structure that includes a substrate, an insulation layer, a passivation layer, a pixel electrode, a common voltage connecting line and a select line. The insulation layer is formed on the substrate, the passivation layer is formed on the insulation layer, and the pixel electrode is formed on the passivation layer. The common voltage connecting line is located between the substrate and the insulation layer. The select line is also located between the substrate and the insulation layer. The common voltage connecting line and the pixel electrode form a storage capacitor while the select line and the pixel electrode form a coupling capacitor.

From another point of view, the present invention also provides a pixel structure that includes a substrate, an insulation layer, a passivation layer, a pixel electrode, a common voltage connecting line and a select line. The insulation layer is formed on the substrate, the passivation layer is formed on the insulation layer, and the pixel electrode is formed on the passivation layer. The common voltage connecting line is located between the substrate and the insulation layer. The select line is located between the insulation layer and the passivation layer. The common voltage connecting line and the pixel electrode form a storage capacitor while the select line and the pixel electrode form a coupling capacitor.

In a preferred embodiment of the present invention, the storage capacitor and the liquid crystal capacitor of the pixel structure can obtain an impulse signal from the coupling capacitor so that the root-mean-square value of the pixel voltage is higher than the critical voltage. Therefore, the white state voltage can be closer to the critical voltage so as to increase the light transmittance of liquid crystals during displaying a white image.

In the present invention, the coupling capacitor is connected in parallel with the liquid crystal capacitor so that the coupling capacitor can provide an over-driving voltage to the liquid crystal capacitor. The preferred embodiment of the present invention at least includes:

1. Even though the lowest pixel voltage of the liquid crystal is not high enough, the liquid crystal can still be maintained in the bend state so as to the image can be still displayed normally.

2. During displaying a white image, the liquid crystals will not change state due to insufficient driving ability of the driving voltage.

3. The operating voltage range of the pixel is increased.

4. The white state voltage can be closer to the critical voltage so as to increase the light transmittance of the liquid crystals during displaying a white image.

In order to male the aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing a functional relation between voltage across a liquid crystal with OCB mode and light transmittance.

FIG. 2 is a waveform diagram showing the voltage variation of an impulse.

FIG. 3 is a waveform diagram showing the voltage variation of a multiple of impulses.

FIG. 4 is an equivalent circuit diagram of a single TFT pixel according to an embodiment of the present invention.

FIG. 5 is an equivalent circuit diagram of a LCD pixel according to an embodiment of the present invention.

FIG. 6 is an equivalent circuit diagram of a LCD pixel according to an embodiment of the present invention.

FIG. 7 is an equivalent circuit diagram of a LCD pixel according to an embodiment of the present invention.

FIGS. 8A˜8F are diagrams showing a few pixel structures according to the embodiments of the present invention.

FIGS. 9A˜9F are schematic cross-sectional views showing a few pixel structures according to the embodiments of the present invention.

FIG. 10 is a flow diagram illustrating the steps for operating a pixel according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The light transmittance of a liquid crystal is determined by the electric field applied to the liquid crystal. When the electric field applied to the liquid crystal is changed before the liquid crystal starts to react, the deviations of the liquid crystal are affected by the change in the electric field due to the viscosity coefficient and the elasticity coefficient of the liquid crystal material. In other words, the arrangement of the liquid crystal is determined by the mean of the torque applied to the liquid crystal by the electric field per unit time, and the torque is proportional to the square of the magnitude of the electric field. Because the light transmittance is related to the arrangement of the liquid crystal, the light transmittance is related to the Root-Mean-Square (RMS) value of the driving voltage. The equation is as follow:

$${V}_{RMS} = {\{ {\int }_{0}^{T} {[ V ( t ) ]}^{2} d t / T \}}^{\frac{1}{2}}$$

wherein, V(t) is a voltage function of time, and T is the variation period of V(t).

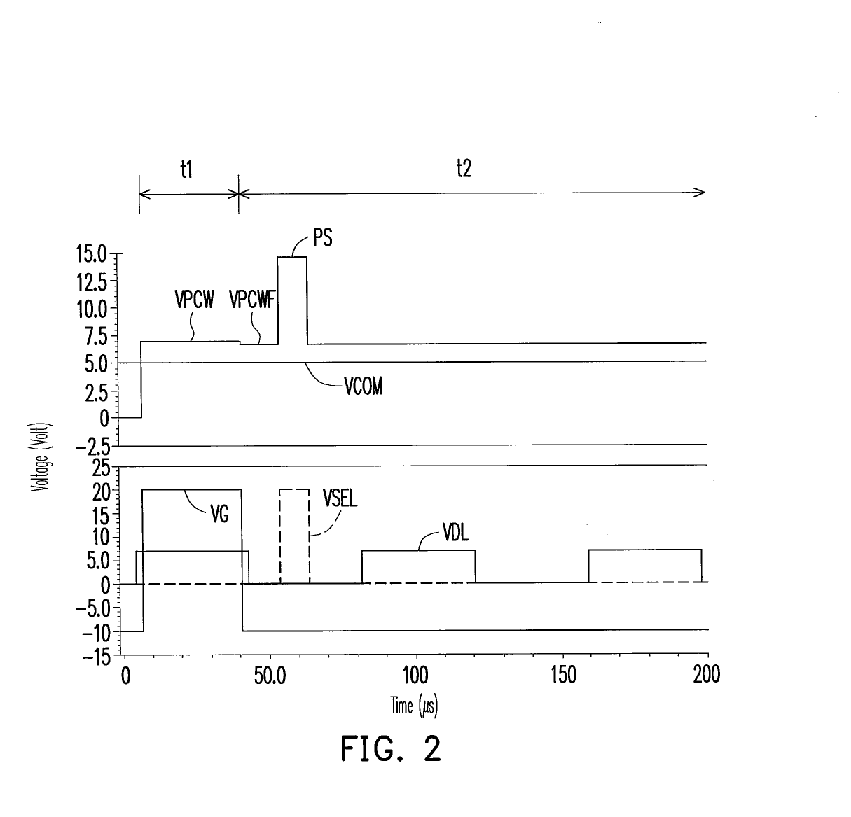

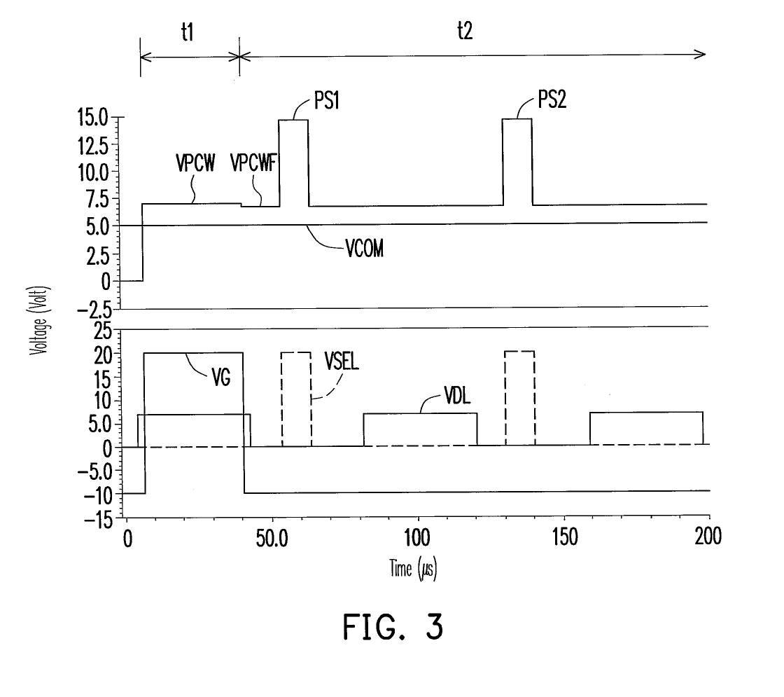

Using the theory mentioned above, a group or multiple groups of impulse signals can be applied to the pixel voltage to resolve the problem encountered in the prior technique. As shown in FIGS. 2 and 3, a white state voltage VPCW is the smallest one of the liquid crystal voltages for displaying a white image. This white state voltage VPCW may drop a little due to a leakage current in the thin film transistor or other adverse effect of the capacitor. As indicated in FIGS. 2 and 3, the liquid crystal voltage is equal to the white state voltage VPCW in the charging period t1. However, when the liquid crystal steps into the maintenance period t2, the white state voltage VPCW is slightly lowered to a white state voltage with lower voltage potential VPCWF. When this white state voltage with lower voltage potential VPCWF is lower than the critical voltage VCR, the liquid crystal changes from a bend state to a splay state. However, if the RMS value of the liquid crystal voltage is maintained higher than critical voltage VCR, the liquid crystal is still in the bend state. Therefore, by adding one or more impulse signals (for example, the impulse signal PS in FIG. 2 and the impulse signals PS1 and PS2 in FIG. 3) in the liquid crystal reaction period t2, the RMS voltage of the liquid crystal reaction period can be increased to a value larger than the critical voltage VCR.

The gate voltage VG indicates the gate driving voltage on a scan line used for turning on a corresponding scan line. The data line supply voltage VDL indicates the voltage outputted by the data line. The over-driving voltage VSEL outputted by the select line can have the waveform of an impulse signal (for example, PS, PS1 and PS2). The common voltage VCOM indicates the voltage level of the common voltage.

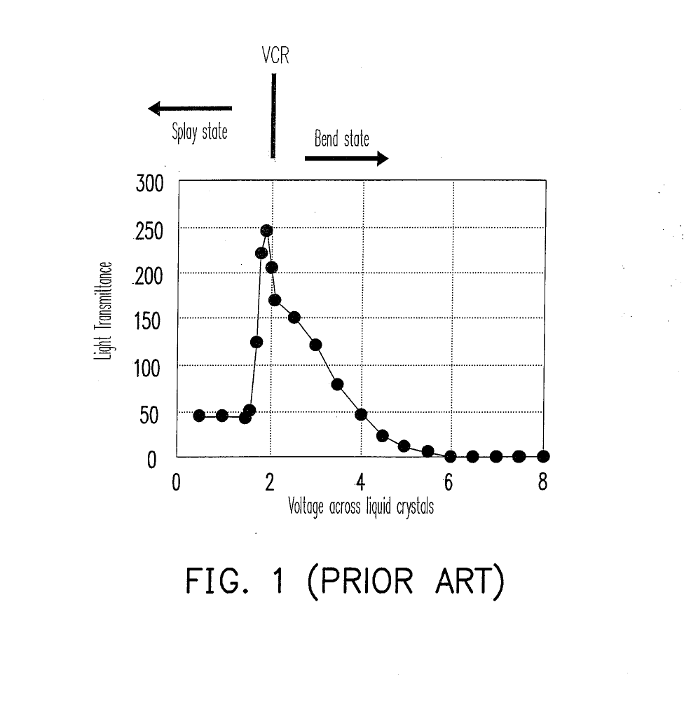

Through the impulse signal PS, though when the white state voltage with lower potential VPCWF, which has a lower potential, is finally equal to or lower than the critical voltage VCR, the liquid crystal still will not change into the hard controlled splay state. Therefore, in actual applications, the foregoing method allows the white state voltage VPCW to operate closer to the critical voltage VCR. As show in FIG. 1, the closer the white state voltage VPCW is to the critical voltage VCR, the higher the light transmittance is. As a result, a brighter white image can be displayed, and the voltage operating range of the liquid crystal for changing from a black image to a white image can be expanded.

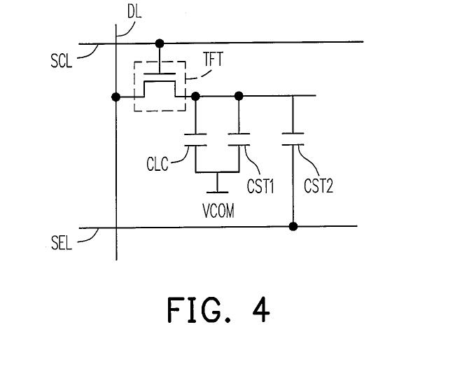

FIG. 4 is an equivalent circuit diagram of a single TFT pixel according to an embodiment of the present invention. As shown in FIG. 4, the pixel includes a transistor TFT, a storage capacitor CST1, a liquid crystal capacitor CLC and a coupling capacitor CST2. The first end of the transistor TFT is coupled to a data line DL, and the liquid crystal capacitor CLC is coupled between the second end of the transistor TFT and a common voltage VCOM. A scan line SCL controls the gate of the transistor TFT. The common voltage VCOM is a reference voltage that can be a ground voltage or a voltage determined by the actual requirements. The coupling capacitor CST2 is coupled between the second end of the transistor TFT and a select line SEL. In the present embodiment, the transistor TFT can be a Thin Film Transistor (TFT).

In addition, the storage capacitor CST1 is connected in parallel with the liquid crystal capacitor CLC so as to increase the energy storage capacity of the liquid crystal capacitor CLC. After charging the liquid crystal capacitor CLC, negative effects such as a leakage current in the transistor TFT may lead to a lowering of the pixel voltage. The parallel connection between the storage capacitor CST1 and the liquid crystal capacitor CLC can generate a larger capacitance, and store more electric charges so that the rate of lowering of the pixel voltage can be attenuated.

After a voltage is stored in the liquid crystal capacitor CLC and the storage capacitor CST1 by the data line DL through the transistor TFT, the select line SEL couples an over-driving voltage (for example, VSEL) to the liquid crystal capacitor CLC through the coupling capacitor CST2. Within a short period of time, the pixel voltage is increased, and the over-driving voltage generates an impulse signal (for example, PS in FIGS. 2 and 3) in a pixel voltage so as to increase the RMS voltage within the reaction time of the liquid crystal. Therefore, even though the pixel voltage is subsequently lower than the critical voltage VCR due to leakage current or other factors, the resultant torque on the liquid crystal is still large enough to maintain the liquid crystal in the bend state.

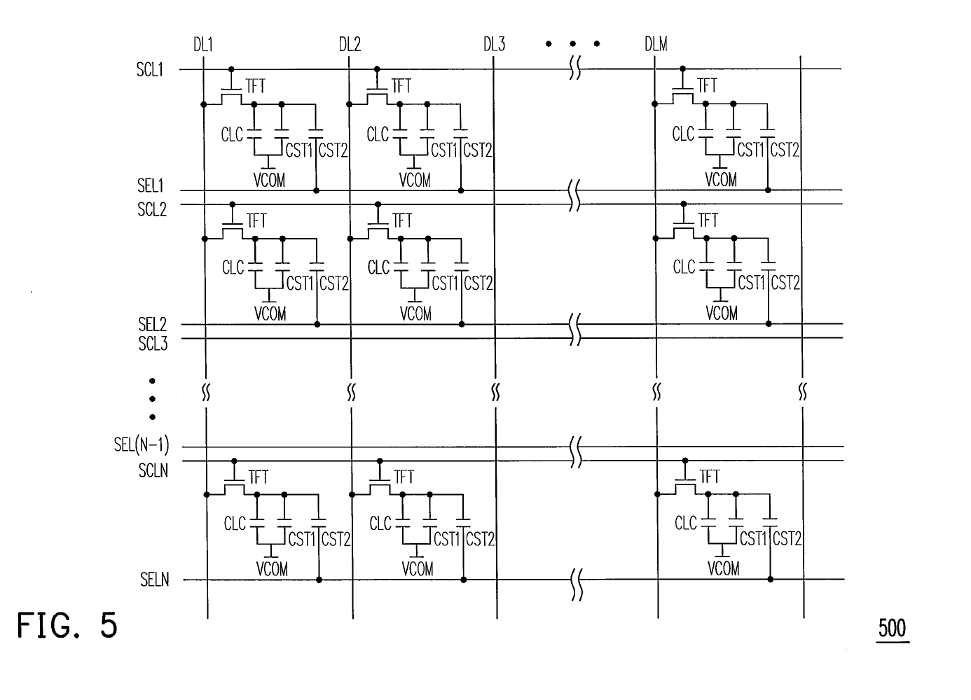

The driving method and pixel structure in the foregoing embodiment can be applied to an OCB LCD with frame inversion mode, row inversion mode, column inversion mode and dot inversion mode. FIG. 5 is an equivalent circuit diagram of a LCD pixel according to another embodiment of the present invention. The display 500 includes a plurality of pixels, each pixel structure as shown in FIG. 4. The scan lines SCL1˜SCLN correspond to a plurality of liquid crystal capacitors CLC, wherein each row of liquid crystal capacitors corresponds to a select line, and the data lines DL1˜DLM are used for driving the liquid crystal capacitors CLC. After a row of liquid crystal capacitors CLC is charged by the data lines DL1˜DLM, the corresponding select line outputs an over-driving voltage to the same row of liquid crystal capacitors CLC according to the driving polarities of the corresponding data lines DL1˜DLM. The variation of the pixel voltage is as shown in FIG. 2. After voltages outputted from the data lines DL1˜DLM, the select lines SEL1˜SELN couple an over-driving voltage (an impulse signal in the present embodiment) to corresponding liquid crystal capacitors through the coupling capacitors CST2. As a result, the RMS of the voltage difference between the two ends of the liquid crystal capacitor CLC is maintained higher than the critical voltage VCR. Therefore, even though the white state voltage VPCW is lower than the critical voltage VCR, the resultant torque on the liquid crystals is still large enough to maintain the liquid crystals in the bend state.

The over-driving voltages output by the select lines SEL1˜SELN will change according to the driving polarities of the data lines DL1˜DLM. When the data lines DL1˜DLM drive with positive polarity, the over-driving voltage is positive. On the other hand, when the data lines DL1˜DLM drive with negative polarity, the over-driving voltage is negative. Therefore, the embodiment in FIG. 5 is applicable to a display has the driving method with frame inversion mode or row inversion mode.

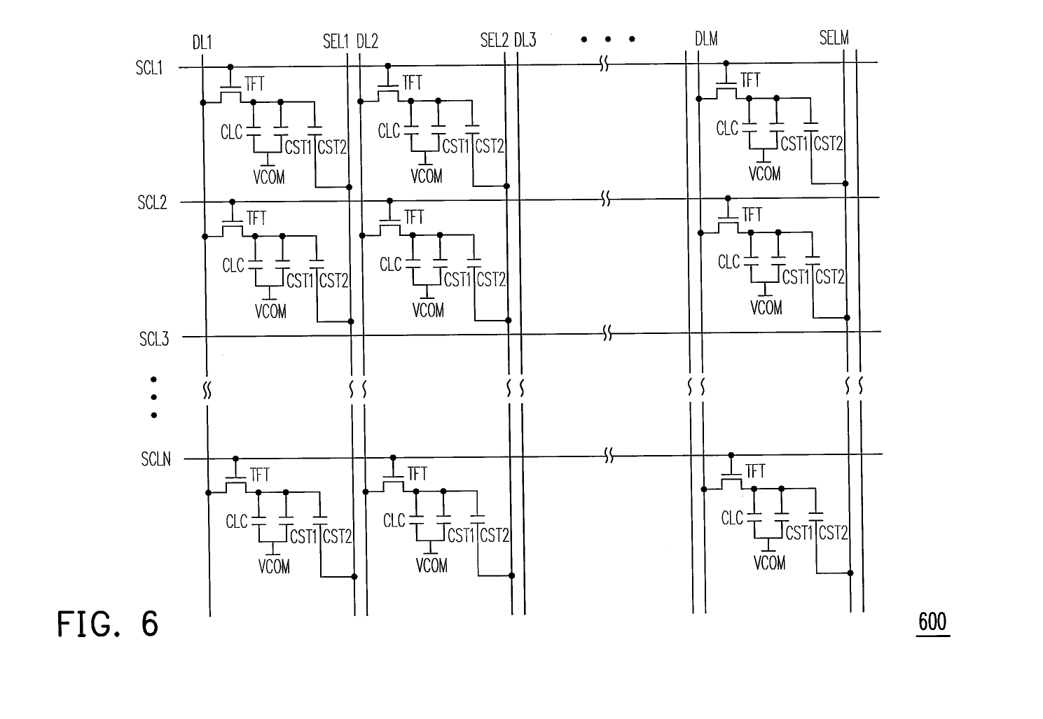

The LCD in FIG. 6 is suitable for column inversion mode. FIG. 6 is an equivalent circuit diagram of a LCD pixel according to another embodiment of the present invention. Because the driving polarity of column inversion is defined with respect to the columns, the data lines DL1˜DLM and the select lines SEL1˜SELM in the embodiment shown in FIG. 6 are one-to-one. The select lines SEL1˜SELM output corresponding over-driving voltages to the liquid crystal capacitors CLC according to the driving polarities of the data lines DL1˜DLM. Because the select lines SEL1˜SELM can change according to the driving polarities of the data lines DL1˜DLM, the pixel circuit diagram shown in FIG. 6 can be applied to a dot inversion display in another embodiment of the present invention.

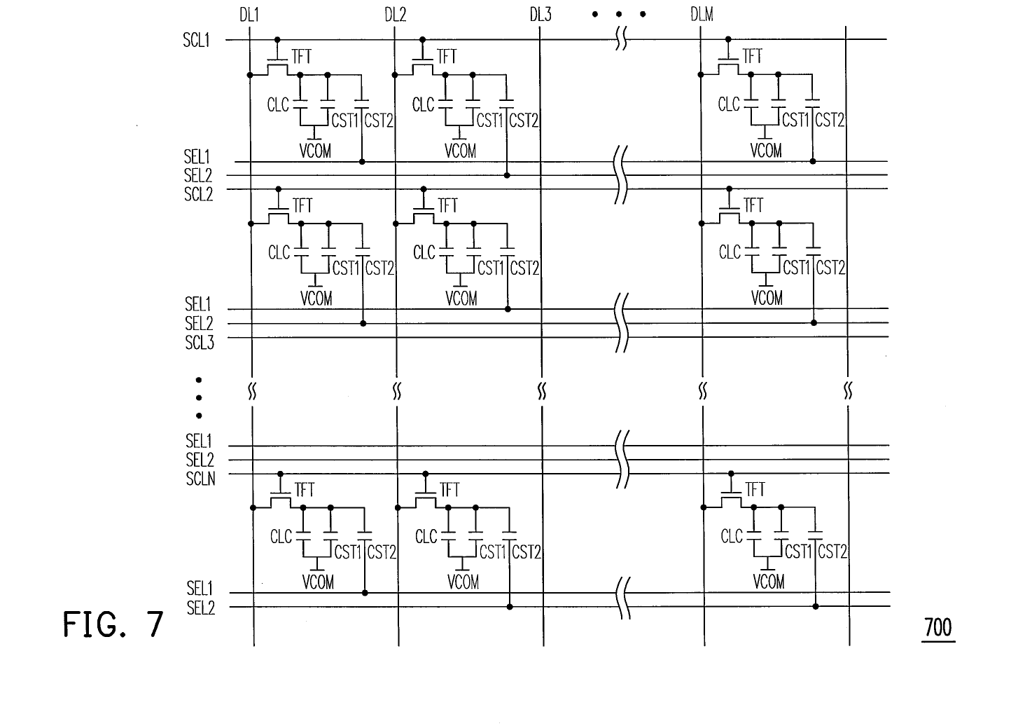

In another embodiment of the present invention, the display can dispose two select lines in each row of pixel capacitors (to indicate the equivalent capacitance of the pixels) so as to adapt to the driving method with dot inversion mode. FIG. 7 is an equivalent circuit diagram of a LCD pixel according to another embodiment of the present invention. Because the driving polarity of dot inversion mode is defined by individual pixel, driving polarities of adjacent pixel are different. Therefore, each scan line corresponds to two select lines, and the select lines are alternately coupled (for example, the select line SEL1 is coupled to the odd-numbered pixels while the select line SEL2 is coupled to the even-numbered pixels or vice versa) to the same row (scan line) of pixel capacitors in the embodiment of FIG. 7. Using the select lines SEL1 and SEL2 as an example, the driving polarities of the select line SEL1 and the select line SEL2 are opposite and vary with the data lines DL1˜DLM. In the driving method with dot inversion mode, adjacent pixels need different driving polarities. After charging the liquid crystal capacitors CLC through the data lines DL1˜DLM, the select lines SEL1 and SEL2 output corresponding over-driving voltages to the liquid crystal capacitors CLC according to the driving polarities of the data lines DL1˜DLM so as to maintain the liquid crystals in the bend state.

For a description of the pixel structures in FIGS. 5˜7 is to refer FIG. 4. Similarly, for a description of the voltage waveform of the pixel is to refer FIGS. 2 and 3. Since anyone skilled in the art can easily deduce from the information disclosed in the present invention other details of the operations of the circuits shown in FIGS. 5˜7, a detailed description is omitted.

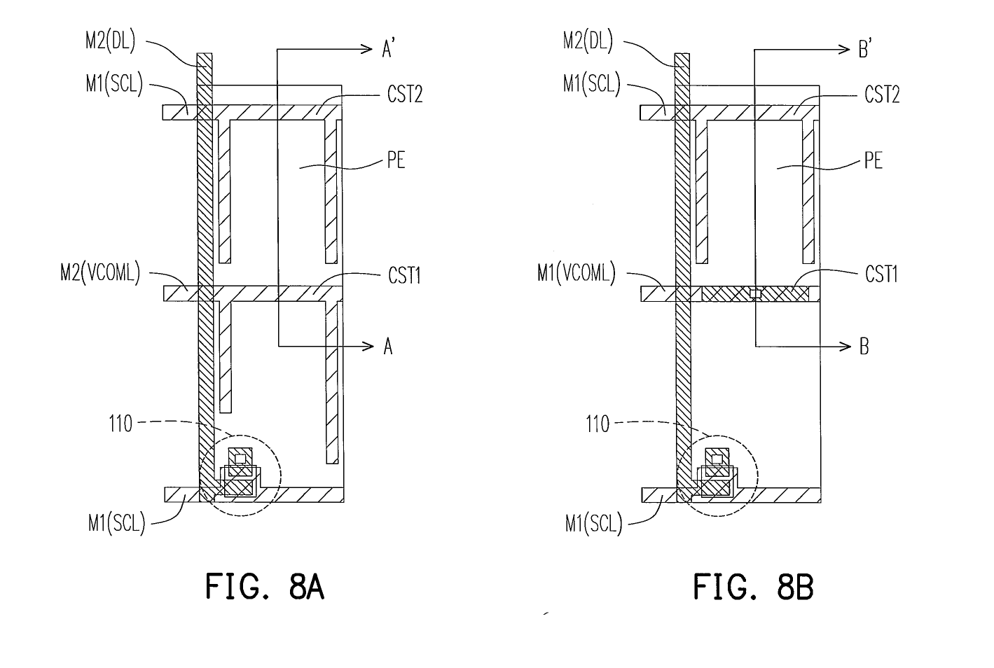

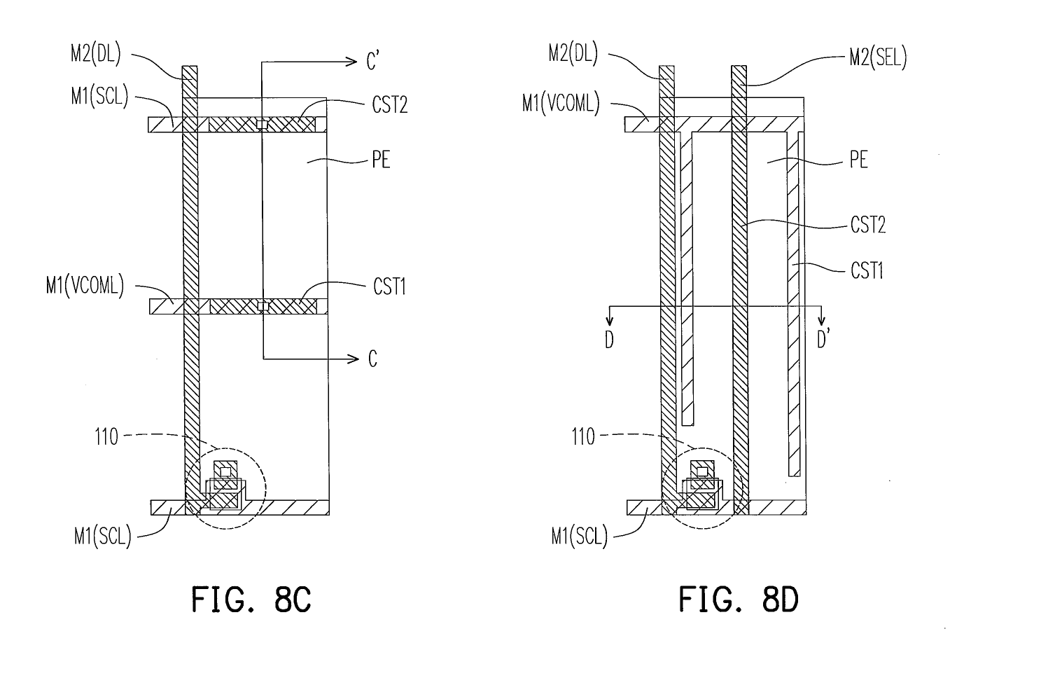

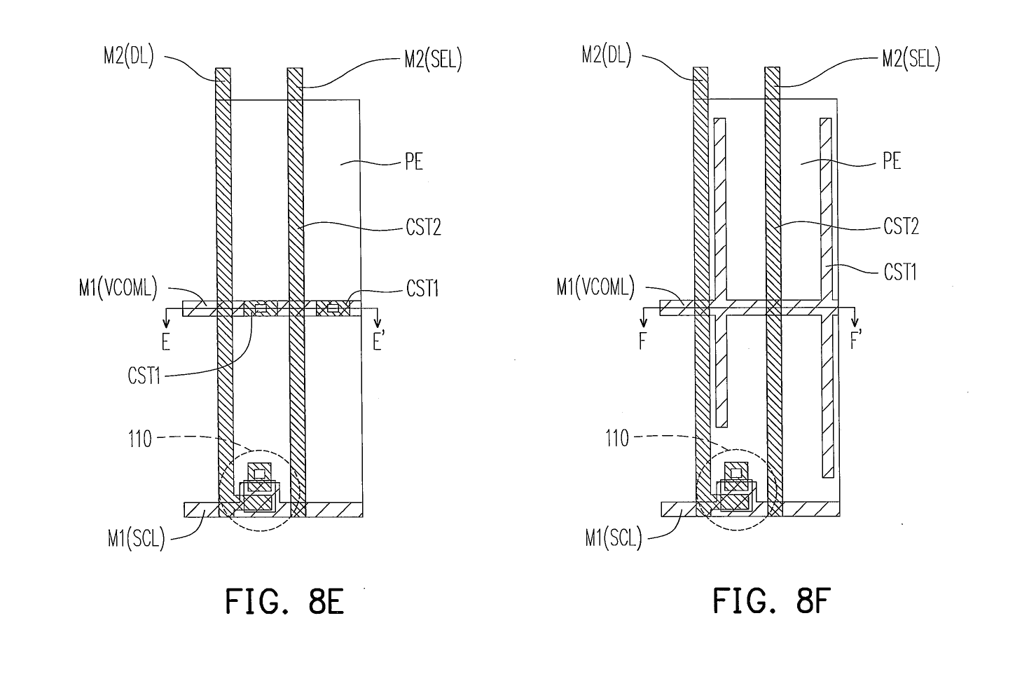

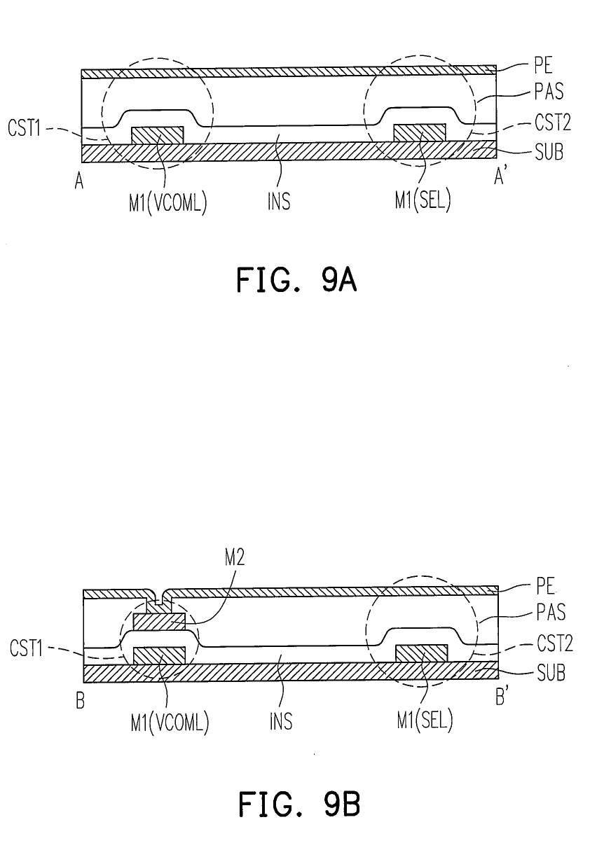

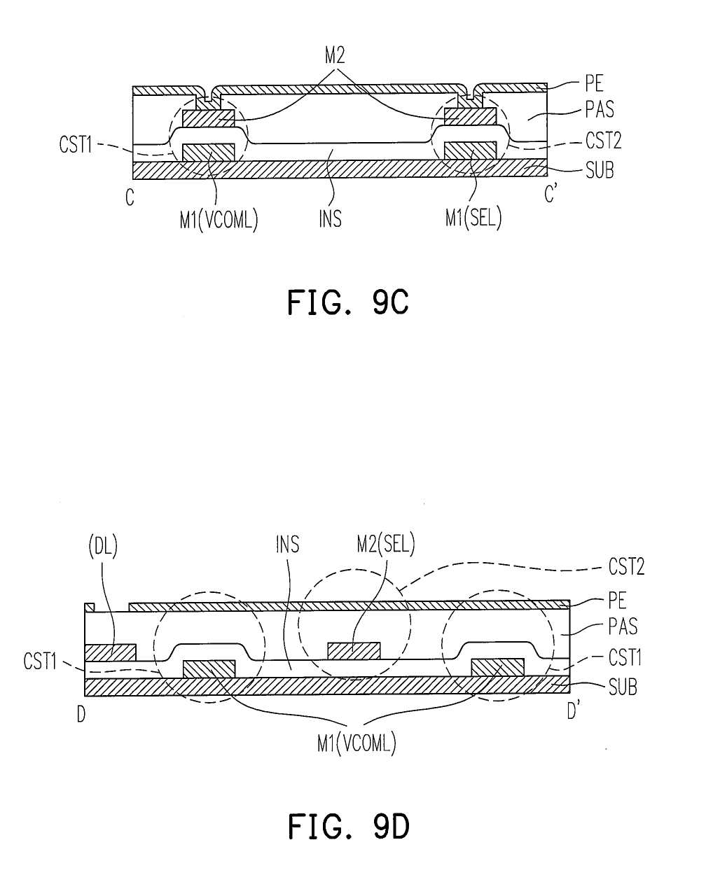

The present invention also provides six kinds of layouts that can be used to form the pixel structure shown in FIGS. 4˜7. However, the present invention is not limited by these layouts. In the following, refer to FIGS. 4, 8A˜8F and 9A˜9F, FIGS. 9A˜9F are schematic cross-sectional views of FIGS. 8A˜8F, respectively. FIGS. 8A˜8F are diagrams showing a few pixel structures according to the embodiments of the present invention. In the present embodiment, the transistor 110 is, for example, a thin film transistor formed by a standard process so that a detailed description is omitted. The two ends of the liquid crystal capacitor CLC are the pixel electrode PE and the common voltage VCOM. The storage capacitor CST1 is connected in parallel with the liquid crystal capacitor CLC. The storage capacitor CST1 can be formed by using the pixel electrode PE and a common voltage connecting line VCOML (formed by using a first metal layer M1 in the present embodiment), or the pixel electrode PE and a second metal layer M2. The common voltage connecting line VCOML is disposed inside the panel and coupled to the common voltage VCOM. The coupling capacitor CST2 can be formed by using the pixel electrode PE and the select line SEL. In the present embodiment, the select line SEL can be formed by using the first metal layer M1 and the second metal layer M2. In other words, the coupling capacitor CST2 can be formed by using the pixel electrode PE and the first metal layer M1, the pixel electrode PE and the second metal layer M2, or the first metal layer M1 (for example, the metal layer of the select line SEL) and the second metal layer M2.

Next, FIGS. 8A˜8F and FIGS. 9A˜9F are used in the description. The process of fabricating a liquid crystal display mainly includes forming five layers, namely, a substrate SUB, a first metal layer M1, an insulation layer INS, a second metal layer M2 and a passivation layer PAS.

First, the layouts in FIGS. 8A˜8C are explained in detail. In FIGS. 8A˜8C, the first metal layer M1 forms the layout of both the common voltage VCOM and the select line SEL. In FIG. 8A, the storage capacitor CST1 and the coupling capacitor CST2 are formed mainly by using the first metal layer M1 and the pixel electrode PE. In FIG. 8B, the storage capacitor CST1 is formed mainly by using the first metal layer M1 and the second metal layer M2. The coupling capacitor CST2 is formed mainly by using the first metal layer M1 and the pixel electrode PE. In FIG. 8C, the storage capacitor CST1 and the coupling capacitor CST2 are formed mainly by using the first metal layer M1 and the second metal layer M2.

From a processing point of view, refer to FIGS. 9A˜9C, which are schematic cross-sections of FIGS. 8A 8C. Mainly, the first metal layer M1 are used to form two groups of insulated metal lines on the substrate SUB, one serves as the select line SEL while the other serves as the common voltage connecting line VCOML. Next, the insulation layer INS and the passivation layer PAS are sequentially formed. Thereafter, the pixel electrode PE is disposed on the passivation layer PAS, and the second metal layer M2 is located between the insulation layer INS and the passivation layer PAS. If there is a requirement to form the storage capacitor CST1 (as shown in FIGS. 8B and 8C) having a higher capacitance per unit area from the second metal layer M2 and the first metal layer M2, the pixel electrode PE can connect to the second metal layer M2 through a contact hole.

In FIGS. 8D˜8F, the second metal layer M2 is used to form the select line SEL. The layout of the second metal layer M2 is shown in FIGS. 8D˜8F. For a processing point of view is to refer FIGS. 9D˜9F. The first metal layer M1 forms the layout of the common voltage connecting line VCOML while the second metal layer M2 forms the layout of the select line SEL. In FIGS. 8D and 8F, having schematic cross-sectional views shown in FIGS. 9D and 9F, the storage capacitor CST1 is formed mainly by using the first metal layer M1 and the pixel electrode PE and the coupling capacitor CST2 is formed mainly by using the second metal layer M2 and the pixel electrode PE. In FIG. 8E having a schematic cross-sectional view shown in FIG. 9E, the storage capacitor CST1 is formed mainly by using the first metal layer M1 and the second metal layer M2, and the coupling capacitor CST2 is formed mainly by using the second metal layer M2 and the pixel electrode PE.

The pixel structures shown in FIGS. 8A˜8E are only embodiments of the present invention. The layout method in the present invention is basically unrestricted. The designer may adjust the layout method according to the actual layout requirements. Since anyone skilled in the art can easily deduce from the information disclosed in the present invention the details of other possible layout methods, a detailed description is omitted.

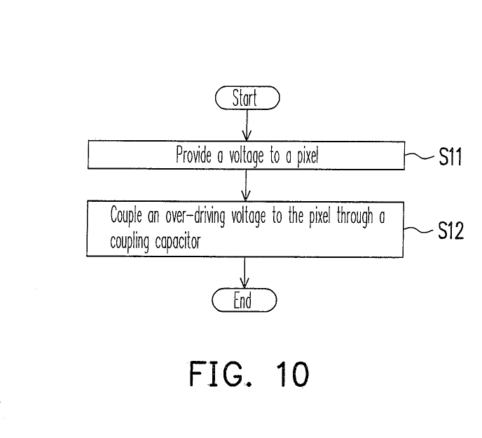

From another point of view, the foregoing embodiment can be regarded as a driving method. FIG. 10 is a flow diagram illustrating the steps in a pixel driving method according to another embodiment of the present invention. First, a voltage is provided to a pixel (step S11). Thereafter, an over-driving voltage is coupled to the pixel through a coupling capacitor (step S12). In real applications, a data line provides the voltage, and a select line provides the over-driving voltage. The over-driving voltage forms an impulse signal on the voltage provided by the data line for increasing the RMS pixel voltage to a value higher than the critical voltage. Thus, even though the white state voltage is equal to or lower than the critical voltage, the liquid crystals are still maintained in the bend state. Therefore, the voltage operating range of the pixel is expanded.

In the aforementioned pixel structure, the liquid crystal capacitor obtains an impulse signal from the coupling capacitor so that the RMS pixel voltage is higher than the critical voltage. As a result, the white state voltage is closer to the critical voltage, and the light transmittance of the liquid crystal displaying a white image is increased.

In summary, because the coupling capacitor provides an over-driving voltage to produce an impulse signal in the voltage provided by the data line in the embodiment of the present invention, the following advantages are produced:

1. Even though the white state voltage of the liquid crystal is lower than the critical voltage, the liquid crystal can still be maintained in the bend state and display images normally.

2. When the OCB LCD displays a white image, the liquid crystals with OCB mode will not change to a splay state due to insufficient driving ability of the driving voltage.

3. The voltage operating range of the pixel is expanded.

4. The white state voltage can be closer to the critical voltage so that the light transmittance of the liquid crystals is increased during displaying a white image.

5. The pixel structure in the foregoing embodiments can be applied to OCB LCD with different types of pixel polarity inversions.

6. Anyone skilled in the art can easily implement the foregoing embodiments according to the process layout disclosed in those embodiments without incurring extra cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel, comprising:
a transistor, having a first end coupled to a data line;
a liquid crystal capacitor, coupled to between a second end of the transistor and a common voltage; and
a coupling capacitor, coupling between the second end of the transistor and a select line.

2. The pixel of claim 1, wherein a gate of the transistor is coupled to a scan line and the second end of the transistor.

3. The pixel of claim 1, further comprising a storage capacitor connected in parallel with the liquid crystal capacitor.

4. The pixel of claim 1, wherein the select line outputs an over-driving voltage to the coupling capacitor and couples to the liquid crystal capacitor after a voltage is output to the liquid crystal capacitor through the data line.

5. The pixel of claim 4, wherein the over-driving voltage is an impulse signal.

6. The pixel of claim 1, wherein the pixel is suitable for an Optically Compensated Bend mode Liquid Crystal Display.

7. The pixel of claim 1, wherein the transistor is a thin film transistor.

8. A liquid crystal display, comprising:
a first scan line, corresponding to a plurality of first pixels;
a plurality of data lines, for driving the first pixels; and
a first select line, for outputting a first over-driving voltage to the first pixels according to driving polarities of the data lines;
wherein the first select line outputs the first over-driving voltage to the first pixels after charging the first pixels through the data lines.

9. The liquid crystal display of claim 8, further comprising:
a second scan line, corresponding to a plurality of second pixels; and
a second select line, for outputting a second over-driving voltage to the second pixels according to driving polarities of the data lines;
wherein the second select line outputs the second over-driving voltage to the second pixels after charging the second pixels through the data lines.

10. The liquid crystal display of claim 8, wherein the first pixel comprises:
a transistor, having a first end coupled to the first data line and a gate coupled to the first scan lie;
a liquid crystal capacitor, coupled between a second end of the transistor and a common voltage; and
a coupling capacitor, coupled between the second end of the transistor and the first select line.

11. The liquid crystal display of claim 10, wherein the first pixel further comprises a storage capacitor connected in parallel with the liquid crystal capacitor and coupled to the second end of the transistor.

12. The liquid crystal display of claim 10, wherein the transistor is a thin film transistor.

13. The liquid crystal display of claim 8, wherein the first over-driving voltage is an impulse signal.

14. The liquid crystal display of claim 8, wherein the liquid crystal display is an Optically Compensated Bend mode Liquid Crystal Display.

15. A liquid crystal display, comprising:
a first data line, for driving a plurality of first pixels; and
a first select line, for outputting a first over-driving voltage to the first pixels according to a driving polarity of the first data line;
wherein the first select line outputs the first over-driving voltage to the first pixels after charging the first pixels through the first data line.

16. The liquid crystal display of claim 15, further comprising:
a second data line, for driving a plurality of second pixels; and
a second select line, for outputting a second over-driving voltage to the second pixels according to a polarity of the second data line;
wherein the first second line outputs the second over-driving voltage to the second pixels after charging the second pixels through the second data line.

17. The liquid crystal display of claim 15, wherein the first pixel comprises:
a transistor, having a first end coupled to the first data line and a gate coupled to the first scan lie;
a liquid crystal capacitor, coupled between a second end of the transistor and a common voltage;
a coupling capacitor, coupled between the second end of the transistor and the first select line; and
a storage capacitor, connected in parallel with the liquid crystal capacitor and coupled to the second end of the transistor.

18. A liquid crystal display, comprising:
a scan line, corresponding to a first pixel and a second pixel, wherein the first pixel corresponds to a first data line and the second pixel corresponds to a second data line;
a first select line, outputting a first over-driving voltage to the first pixel according to a driving polarity of the first data line; and
a second select line, outputting a second over-driving voltage to the second pixel according to a driving polarity of the second data line;
wherein the first select line outputs the first over-driving voltage to the first pixel after charging the first pixel through the first data line, and the second select line outputs the second over-driving voltage to the second pixel after charging the second pixel through the second data line, wherein the first pixel and the second pixel are adjacent to each other and the driving polarity of the first data line and the second data line are opposite to each other.

19. The liquid crystal display of claim 18, wherein the first pixel comprises:
a transistor, having a first end coupled to the first data line and a gate coupled to the first scan line;
a liquid crystal capacitor, coupled between a second end of the transistor and a common voltage;
a coupling capacitor, coupling between the second end of the transistor and the first select line; and
a storage capacitor, connected in parallel with the liquid crystal capacitor.

20. A pixel driving method, comprising:
providing a voltage to a pixel; and
coupling an over-driving voltage to the pixel through a coupling capacitor.

21. The pixel driving method of claim 20, wherein the voltage is provided through a data line and the over-driving voltage is provided through a select line.

22. The pixel driving method of claim 20, wherein the over-driving voltage is an impulse signal.

23. A pixel structure, comprising:
a substrate;
an insulation layer, formed on the substrate;
a passivation layer, formed on the insulation layer;
a pixel electrode, formed on the passivation layer;
a common voltage connecting line, formed between the substrate and the insulation layer; and
a select line, formed between the substrate and the insulation layer;
wherein the common voltage connecting line and a pixel electrode form a storage capacitor, and the select line and the pixel electrode form a coupling capacitor.

24. The pixel structure of claim 23, wherein the select line is formed using a first metal layer.

25. The pixel structure of claim 23, wherein the common voltage connecting line is formed using the first metal layer.

26. A pixel structure, comprising:
a substrate;
an insulation layer, formed on the substrate;
a passivation layer, formed on the insulation layer;
a pixel electrode, formed on the passivation layer;
a common voltage connecting line, formed between the substrate and the insulation layer; and
a select line, formed between the insulation layer and the passivation layer;
wherein the common voltage connecting line and a pixel electrode form a storage capacitor, and the select line and the pixel electrode form a coupling capacitor.

27. The pixel structure of claim 26, wherein the common voltage connecting line is formed using a first metal layer.

28. The pixel structure of claim 26, wherein the second line is formed using a second metal layer.
